(19) United States
(12) Patent Application Publication
(10) Pub. No.: US 2002/0130468 A1
(43) Pub. Date: Sep. 19, 2002

(54) Cylinder head gasket

(76) Inventors: Yukio Kawai, Toyota-Shi (JP); Yoshiyuki Hagiwara, Toyota-Shi (JP); Tomotada Yasuda, Toyota-Shi (JP); Toshiyuki Tanaka, Toyota-Shi (JP); Hiroyuki Murai, Aichi-pref (JP); Shigeki Nakayama, Toyota-Shi (JP); Toshio Suematsu, Toyota-Shi (JP); Takao Fukuma, Toyota-Shi (JP)

Correspondence Address: FLYNN, THIEL, BOUTELL & TANIS, P.C., 2026 Rambling Road, Kalamazoo, MI, 49008-1699, US

(21) Appl. No.: 10/095,189

(22) Filed: Mar. 11, 2002

(30) Foreign Application Priority Data
Mar. 15, 2001 (JP) 74386/2001

(51) Int. Cl. F16J 15/00

(52) U.S. Cl. 277/318

(57) ABSTRACT

A cylinder head gasket includes a pair of first and second outer plates 2, 3 and an inner plate 4 disposed therebetween. The inner plate 4 is formed with containment openings H1 to H10 at given positions therein for receiving sensors S1 to S10. The both outer plates 2, 3 are formed with projections P1 to P10 which project toward the sensor, thus allowing an urging force from a cylinder head or cylinder block to be transmitted to the sensors S1 to S10 through the projections P1 to P10. There can be provided a cylinder head gasket having a sealability comparable to that of a cylinder head gasket not internally housing a sensor while reducing a cost required for parts other than the sensor to be reduced in comparison to the prior art.

### FIELD OF THE INVENTION

The invention relates to a cylinder head gasket used in an engine, and more particularly, to a cylinder head gasket which functions to measure a combustion pressure within a combustion chamber.

### DESCRIPTION OF THE PRIOR ART

A cylinder head gasket internally housing a sensor which measures a combustion pressure within a combustion chamber is known in the art as disclosed in Japanese Laid-Open Patent Applications No. 308, 341/1992 and No. 157,631/1990.

A cylinder head gasket of the kind disclosed affords an increased margin for a mounting space at a reduced cost.

In the former Application cited above, an ion gap sensor held sandwiched between two outer plates so as to face a combustion chamber is designed to measure a combustion pressure, and this disposition results in a degraded sealability between the ion gap sensor and the outer plates or a disadvantage that the sealability of an edge portion around a combustion chamber opening which is important in maintaining a seal is degraded in comparison to a more general cylinder head gasket which does not internally house a sensor.

On the other hand, in the latter Application, the measurement takes place by a sensor mounted in a bottomed opening which is formed in a cylinder head gasket, affording a sealability which is comparable to that attained by a more general cylinder head gasket which does not internally house a sensor. However, an increased number of parts except for the sensor results in a more complex arrangement and an increased cost for parts other than the sensor. Specifically, a cylinder head gasket comprises a pair of outer plates which are held sandwiched between a cylinder head and a cylinder block, a pair of spacers disposed between the both outer plates, and an inner plate disposed between the both spacers. The mounting opening comprises openings of an equal, increased diameter which are formed in one of the outer plates and the adjacent spacer, openings of an equal, reduced diameter which are formed in the other spacer and the inner plate, and a grommet formed in the other outer plate disposed in opposing relationship with the openings of an increased diameter and the openings of a reduced diameter and extending radially outward in a folded manner.

### SUMMARY OF THE INVENTION

In view of the foregoing, the invention provides a cylinder head gasket which offers a sealability comparable to that attained by a cylinder head gasket which does not internally house a sensor and which allows costs required for parts other than the sensor to be reduced as compared with the prior art.

Specifically, according to the present invention, there is provided a cylinder head gasket including a pair of outer plates held sandwiched between a cylinder head and a cylinder block and each having a cylinder chamber opening which is formed in alignment with a cylinder bore, an inner plate disposed between the outer plates and having a combustion chamber opening which is formed in alignment with the cylinder bore, a containment opening formed at a given position in the inner plate, and a sensor received within the containment opening in the inner plate and having a wall thickness less than the inner plate; the cylinder head gasket being arranged such that at least one of the both outer plates is formed with a projection which projects toward the sensor so that any urging force from the cylinder head and the cylinder block can be transmitted to the sensor through the projection.

With the described arrangement, since the sensor is received in the containment opening formed in the inner plate, the edge portion of the combustion chamber opening which has a great influence upon the sealability can be freely constructed without restriction by the sensor. A cost which is required in providing the arrangement according to the invention except for the sensor relates to the cost of providing the containment opening formed in the inner plate and the projection formed on one of the outer plates. In this manner, as compared with a more general cylinder head gasket which does not internally house a sensor, a comparable sealability can be obtained while reducing the costs for parts other than the sensor as compared with the prior art.

Above and other objects, features and advantages of the invention will become apparent from the following description of several embodiments thereof with reference to the attached drawings.

### BRIEF DESCRIPTION OF THE DRAWINGS

FIG. 1 is a plan view of a cylinder head gasket 1 according to a first embodiment of the invention;

FIG. 2 is a cross section, to an enlarged scale, taken along the line A-A shown in FIG. 1;

FIG. 3 is a cross section, to an enlarged scale, taken along the line B-B shown in FIG. 1;

FIG. 4 is a plan view, to an enlarged scale, of an essential part illustrating that a bend 19′ is formed in a notch 19 to allow a slack in a lead wire itself to be produced by a bend 18′;

FIG. 5 is a cross section, to an enlarged scale, of an essential part of a cylinder head gasket 101 according to a second embodiment of the present invention;

FIG. 6 is a cross section, to an enlarged scale, of an essential part of a cylinder head gasket 201 according to a third embodiment of the present invention;

FIG. 7 is a cross section of a projection P in the form of a spherical surface;

FIG. 8 is a cross section of a projection P in the form of a cup which is formed by a sub-plate 22;

FIG. 9 is a cross section of a solid projection P formed by a sub-plate 22; and

FIG. 10 is a cross section of an essential part in which a sensor S5 is sealed by full beads 330, which are formed on outer plates 302 and 303.

### DETAILED DESCRIPTION OF THE EMBODIMENTS

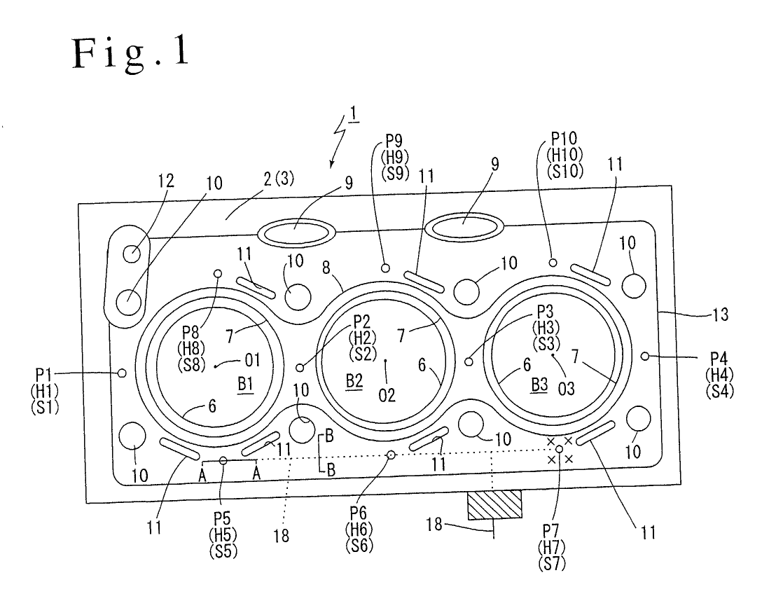

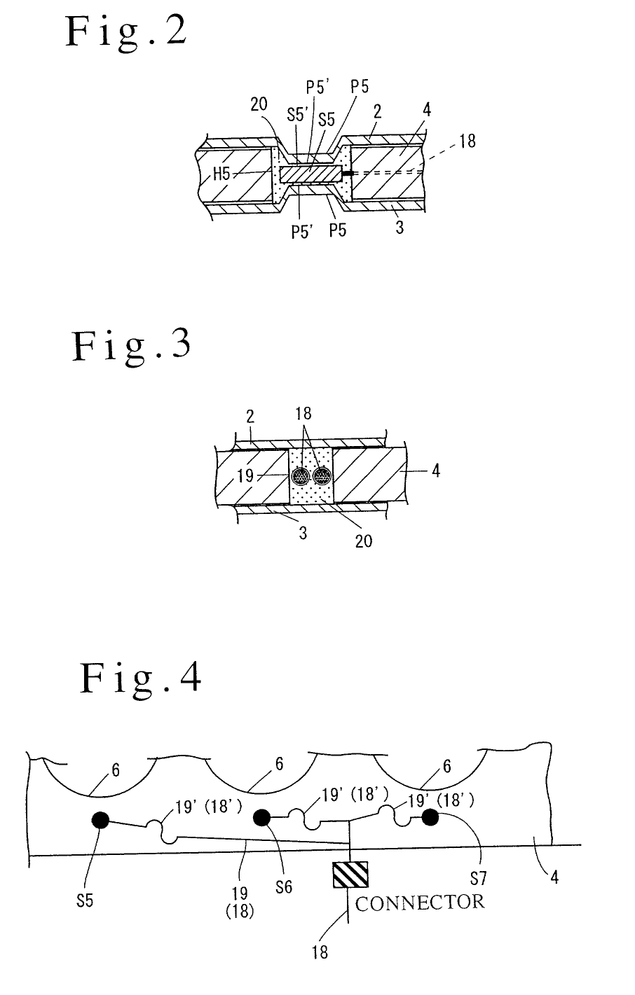

A cylinder head gasket 1 according to the present invention will now be described. Referring to FIGS. 1 and 2, the cylinder head gasket 1 comprises a first outer plate 2 which is disposed on the side of a cylinder block, not shown, a second outer plate 3 which is disposed on the side of a cylinder head, not shown, and an inner plate 4 which is disposed between the first outer plate 2 and the second outer plate 3. The first and second outer plate 2, 3 and the inner plate 4 are integrally connected together as by lance lock, for example.

The first outer plate 2 and the second outer plate 3 are formed of a common material having an equal sheet thickness, and in the present embodiment, the both have an equal rigidity. The first and the second outer plate 2, 3 and the inner plate 4 are formed with first to third, concentric combustion chamber openings 6 which are formed in alignment with respective combustion chambers B1 to B3, respectively. Each of the first and the second outer plate 2, 3 is formed with an inner bead 7 which surrounds each combustion chamber opening 6 individually, an intermediate bead 8 which surround the inner beads 7 collectively and an outer bead 13.

It will be seen that the first and the second outer plate 2, 3 and the inner plate 4 are formed with blowby openings 9, bolt openings 10, water openings 11 and oil openings 12 at locations between the intermediate bead 8 and the outer bead 13.

The cylinder head gasket 1 described above is interposed between a cylinder block and a cylinder head, which are integrally connected together by clamping bolts, not shown, whereby the cylinder head gasket 1 is held sandwiched between the cylinder block and the cylinder head to provide a seal therebetween.

There is proposed a cylinder head gasket which internally houses a sensor for measuring a combustion pressure within a combustion chamber. With this cylinder head gasket, the sealability becomes degraded in comparison to a more general cylinder head gasket which does not internally houses a sensor. Alternatively, in order to secure a sealability comparable to the general cylinder head gasket which does not internally house a sensor, there is a need to increase the number of parts, resulting in a complex arrangement and an increased cost for parts other than the sensor disadvantageously.

The present embodiment intends to provided a cylinder head gasket which secures a sealability comparable to more a general cylinder head gasket which does not internally has a sensor while reducing the number of parts and simplifying the arrangement to reduce the cost required.

Specifically, the inner plate 4 is formed with ten circular containment openings or a first to a tenth containment opening H1 to H10 for receiving a first to a tenth sensor S1 to S10 such as piezoelectric sensor in the form of a disc having a reduced wall thickness than the thickness of the inner plate 4 therein. The first and the second outer plate 2, 3 which are disposed on the opposite sides of the inner plate 4 prevent these sensors S1 to S10 from being disengaged from the containment openings H1 to H10.

It should be noted that the number of sensors is not limited to ten, and a required member of sensors may be provided at required locations, or the number of sensors can be suitably changed in accordance with the number of combustion chambers.

Most of the first to the tenth containment opening H1 to H10 are formed at locations which are outside the intermediate beads 8 on the first and the second outer plate 2 and 3, and in the present embodiment, the containment openings H1 to H10 are disposed so that they are equally spaced apart around the circumference of each of the combustion chambers B1 to B3.

More specifically, the first to the fourth containment opening H1 to H4 are located on an imaginary line L, not shown, passing through centers O1 to O3 of the first to the third combustion chamber B1 to B3 while the fifth and the eighth containment opening H5 and H8 are located on a line passing through the center O1 of the first combustion chamber B1 and which is perpendicular to the line L, the sixth and the ninth containment opening H6, H9 are located on a line passing through the center O2 of the second combustion chamber B2 and which is perpendicular to the line L, and the seventh and the tenth containment opening H7, H10 are located on a line passing through the center O3 of the third combustion chamber B3 and which is perpendicular to the line L, thus on the opposite sides of the respective centers.

The second sensor S2 is designed to measure a combustion pressure in each of the first and the second combustion chamber B1 and B2 while the third sensor S3 is designed to measure a combustion pressure in each of the second and third combustion chamber B2 and B3. Because the first to the third combustion chamber B1 to B3 have different combustion timings, which allow a combustion process occurring in a particular combustion chamber to be identified, sharing a sensor between the adjacent combustion chamber openings presents no problem. It is to be understood that the combustion timing can be determined in terms of a fuel injection signal or an angle of rotation of a crank.

The fifth, the sixth and the seventh sensor S5, S6 and S7 are connected to common lead wires 18, which are in turn connected to an external controller. Again, this presents no problem since the first to the third combustion chamber B1 to B3 have different combustion timings. As shown in FIG. 3, the lead wires 18 are received in a notch 19 in the inner plate 4, a positive wire on the right and a negative wire on the left. While not shown, the first and the fourth sensor S1, S4 are connected together by common lead wires as are the second and third sensor S2, S3 and the eighth to the tenth sensor S8 to S10.

In the present embodiment, the first to the tenth sensor S1 to S10 and associated lead wires are coated by a resin sealant 20 to protect them from water and oil (see FIG. 3).

It will be seen that because each of the first to the tenth sensor S1 to S10 has a reduced wall thickness than the inner plate 4, such sensor cannot measure an urging force from a cylinder head and a cylinder block. Accordingly, in the present embodiment, each of the first and the second outer plate 2 and 3 is formed with a first to a tenth projection P1 to P10, which is circular, projecting into the first to the tenth containment opening H1 to H10, respectively, so as to contact each of the first to the tenth sensor S1 to S10 (see FIG. 2 illustrating P5).

In order to improve the accuracy of measurement of the first to the tenth sensor S1 to S10, the first and the second outer plate 2, 3 and the inner plate 4 are integrally connected together by welding (illustrated by X shown around S7 in FIG. 1) at four locations centered about each sensor. In this manner, any slip which may occur between the first outer plate 2 and the inner plate 4 or between the second outer plate 3 and the inner plate 4 is prevented from occurring in response to a thermal expansion and shrinkage between the cylinder head and the cylinder block.

The first to the tenth projection P1 to P10 each have a flat contact surface P1′ to P10′ , respectively (see FIG. 2 illustrating only P5′ ), which is chosen to be smaller than a pressure responsive surface S1′ to S10′ (FIG. 2 illustrating only S5′ ) of the first to the tenth sensor S1 to S10, respectively. In this manner, it is assured that a constant contact area can be maintained between the first to the tenth sensor S1 to S10 and the first to the tenth projection P1 to P10 if there should occur a displacement between the inner plate 4 and either outer plate 2 or 3 as a result of the thermal expansion and shrinkage of the cylinder head and the cylinder block.

With the cylinder head gasket 1 constructed in the manner mentioned above, an edge portion of the combustion chamber opening 6 which has a great influence upon the sealability can be freely arranged without any restriction by the provision of the first to the tenth sensor S1 to S10. In other words, the edge portion of the combustion chamber opening 6 can be constructed without the need for a consideration of internally housing a sensor therein. In this manner, a sealability comparable to that obtained in a more general cylinder head gasket which does not internally house a sensor can be obtained. It will be seen that in the present embodiment, what is required except for the first to the tenth sensor S1 to S10 is only the provision of the first to the tenth containment opening H1 to H10 in the inner plate 4 and the provision of the first to the tenth projection P1 to P10 on the first and the second outer plate 2 and 3, thus allowing the cost required for other than the first to the tenth sensor S1 to S10, inclusive of associated lead wires 18, to be reduced as compared with the prior art.

It is expected that a lead wire 18 which is located inside may be loaded as a result of a tension applied to an externally exposed lead wire 18. To accommodate for this, at least each branch of the notch 19 is formed with one or more bends 19′ to allow the lead wire 18 itself which is disposed inside the cylinder head gasket to be formed with a bend 18′ to provide a slack therein which is enough to prevent a breakage form occurring.

Second Embodiment

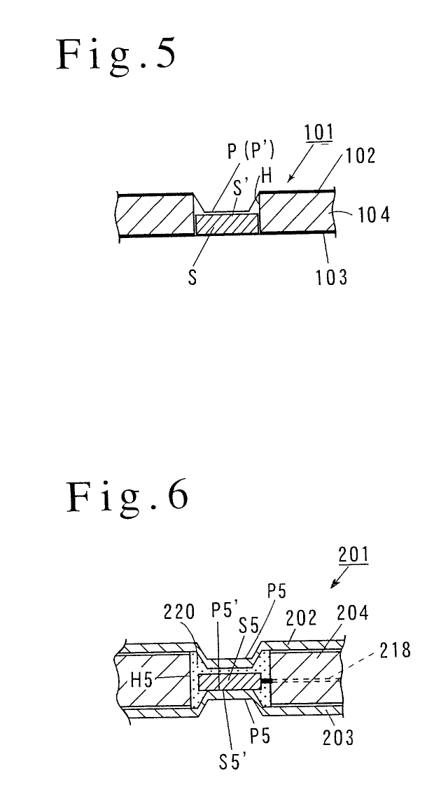

FIG. 5 shows a second embodiment of the present invention. In the first embodiment, projections are formed on both the first and the second outer plate 2, 3, but the projections may be formed on either one of them. In the second embodiment, the projections P are formed only on a first outer plate 102 while a second outer plate 103 remains flat. In other respects, the arrangement is similar to the first embodiment, and accordingly, corresponding parts are designated by like reference numerals as used before, to which 100 is added. Again, a similar functioning and effect can be achieved as in the first embodiment.

Third Embodiment

FIG. 6 shows a third embodiment of the present invention. In the first embodiment, each sensor is connected to a pair of lead wires 18 which may comprise a coaxial cable for the positive and negative terminal of the sensor. In the third embodiment, a positive lead wire 218 alone is connected to each of sensors S1 to S10.

Specifically, as shown for S5 in FIG. 6, each of the sensors S1 to S10 is electrically conductive to a car body, not shown, such as an electrical ground of an engine, for example, through a second outer plate 203 which is electrically conductive. Accordingly, each of the sensors S1 to S10 is urged by a sealant 220 which comprises an insulating material so that only its one pressure responsive surface (indicated as S5′ ) is maintained in abutment against one of the projections P1 to P10 (which is illustrated for P5) on the second outer plate 203.

In other respects, the arrangement is similar to the first embodiment, and accordingly, corresponding parts are designated by like reference numerals as used before, to which 200 is added. Again, a similar functioning and effect can be obtained as in the first embodiment while reducing the cost required.

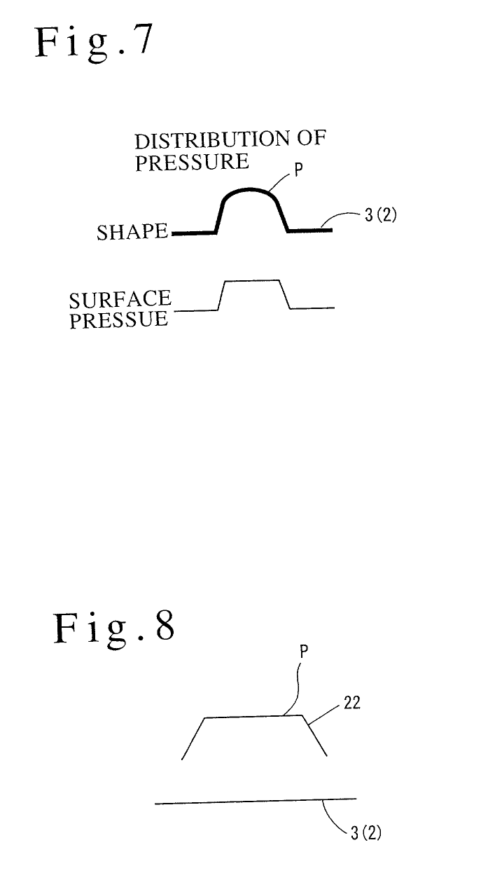

In the first and the second embodiment, the first to the tenth projection P1 to P10 each have a flat contact surface P1′ to P10′, respectively, but the invention is not limited thereto. As shown in FIG. 7, the projection P itself may be formed into a spherical configuration projecting toward the sensor S, and this allows a uniform distribution of pressure to be obtained against the pressure responsive surface S.

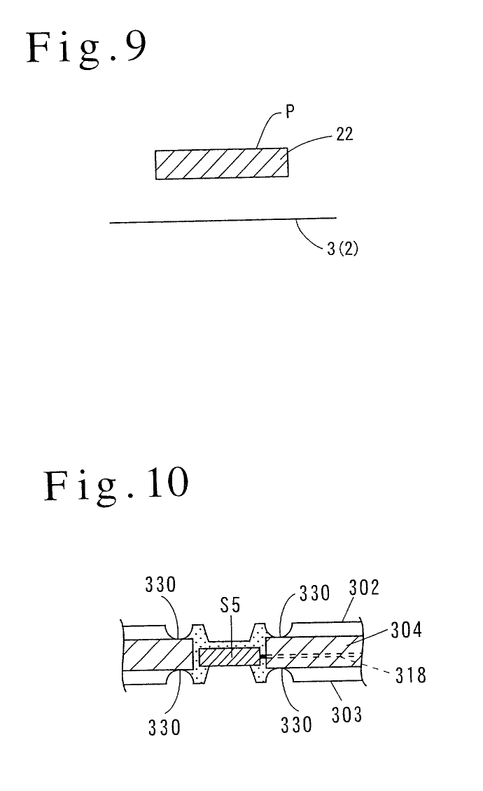

In the first and the second embodiment, the projection P is integrally formed on the first and second outer plate 2, 3 (or the first outer plate 102) by a press operation, but the invention is not limited thereto. Alternatively, the projection P may comprise a cup-shaped sub-plate 22 (see FIG. 8) or a solid sub-plate 22 (see FIG. 9). The sub-plate 22 may or may not be cemented to the outer plate 3 (or 2). In this manner, the material for the sub-plate 22 can be suitably chosen, allowing the spring response of the project P to be changed.

In the first embodiment, the resin sealant 20 is used to seal the sensors S1 to S10 and the lead wires 18, but the invention is not limited thereto. As illustrated in FIG. 10, both outer plates 302 and 303 may be formed with annular full beads 330 (which may be half beads) projecting toward an inner plate 304 for individually surrounding each of sensors S1 to S10, thus locally sealing each of the sensors S1 to S10. While not shown, an annular rubber print may be applied on one of opposing surfaces of either outer plate 2, 3 (302, 303) and an inner plate 4 (304) so as to surround each of sensors S1 to S10 in an individual manner, thus locally sealing each sensor. When the full beads 330 or the rubber prints are used to provide a local seal for the sensors S1 to S10, the sealant 20 may be used to locally coat only the lead wires 18 (318).

In the first embodiment, the notch 19 is formed in the inner plate 4 and the lead wire 18 is disposed in the notch, but the invention is not limited thereto. In place of providing the notch in the inner plate, the lead wire may be replaced by a printed wiring on the surface of the inner plate.

While the invention has been described above in connection with several embodiments thereof, it should be understood that a number of changes, modifications and substitutions therein are possible from the above disclosure without departing from the spirit and scope of the invention defined by the appended claims.

What is claimed is:

1. A cylinder head gasket including a pair of outer plates held sandwiched between a cylinder head and a cylinder block and each having a combustion chamber opening formed in alignment with a cylinder bore, an inner plate disposed between the outer plates and having a combustion chamber opening formed in alignment with the cylinder bore, a containment opening formed in the inner plate at a given position, and a sensor received in the containment opening in the inner plate and having a reduced wall thickness than the inner plate,
the arrangement being such that at least one of the outer plates is formed with a projection projecting toward the sensor, thus allowing an urging force from either the cylinder head or the cylinder block to be transmitted to the sensor through the projection.

2. A cylinder head gasket according to claim 1 in which the both outer plates are formed with projections projecting toward the sensor.

3. A cylinder head gasket according to claim 1 or 2 in which the projection has a contact surface having an area which is less than a pressure responsive area of the sensor.

4. A cylinder head gasket according to one of claims 1 to 3 in which the outer plate is integrally provided with a sub-plate, on which the projection is formed.

5. A cylinder head gasket according to one of claims 1 to 4 in which the projection is cup-shaped, in the form of a hollow cylinder or spherical in configuration.

6. A cylinder head gasket according to one of claims 1 to 5 in which the sensor is formed as a disc and the shape of the projection is circular.

7. A cylinder head gasket according to one of claims 1 to 6 in which the outer plate and the inner plate are integrally connected together at a position adjacent to the sensor.

8. A cylinder head gasket according to one of claims 1 to 7 in which a lead wire having its one end connected to the sensor is passed through a notch formed in the inner plate for connection with an external instrument while the sensor and the lead wire are sealed by seal means.

9. A cylinder head gasket according to one of claims 1 to 8 in which the sensor is disposed in abutment against a conductive outer plate so as to be connected to an electrical ground of a car body through the outer plate.

10. A cylinder head gasket according to one of claims 1 to 9 in which a lead wire having its one end connected to the sensor is formed with a bend therein to prevent a breakage thereof.

11. A cylinder head gasket according to one of claims 1 to 10 in which the pair of outer plates have a uniform wall thickness.
